(19) United States
(12) Patent Application Publication
(10) Pub. No.: US 2026/0155086 A1
(43) Pub. Date: Jun. 4, 2026

(54) DISPLAY APPARATUS AND METHOD OF DRIVING PIXELS THEREOF

(71) Applicant: AUO Corporation, Hsinchu City (TW)

(72) Inventors: Che-Wei Tung, Hsinchu City (TW); Yu-Chieh Kuo, Hsinchu City (TW); Che-Chia Chang, Hsinchu City (TW); Mei-Yi Li, Hsinchu City (TW); Yu-Hsun Chiu, Hsinchu City (TW); En-Chih Liu, Hsinchu City (TW)

(73) Assignee: AUO Corporation, Hsinchu City (TW)

(21) Appl. No.: 18/976,260

(22) Filed: Dec. 10, 2024

(30) Foreign Application Priority Data
Nov. 29, 2024 (TW) 113146170

(51) Int. Cl. G09G 3/32; G09G 3/20

(52) U.S. Cl. CPC G09G 3/32; G09G 3/2092; G09G 3/2018; G09G 2300/0819; G09G 2300/0852; G09G 2300/0861; G09G 2310/0267; G09G 2310/027; G09G 2310/08; G09G 2320/045

(57) ABSTRACT

A display apparatus and method of driving pixels thereof are provided. The display apparatus includes a pixel array, a timing controller, a gate driver, a source driver, and an emission driving circuit. The pixel array has a plurality of self-luminous pixel circuits. The timing controller provides pixel voltage data, at least two scan start signals, and an emission start signal. The gate driver, based on the scan start signals, divides a single frame period into a plurality of sub-frame periods to sequentially activate the self-luminous pixel circuits row by row. The source driver, based on the pixel voltage data, provides a plurality of pixel voltages corresponding to the self-luminous pixel circuits in each sub-frame periods to determine a driving current of an emission element of the self-luminous pixel circuits. The emission driving circuit, based on the emission start signal, provides a plurality of emission signals to the self-luminous pixel circuits.

### CROSS-REFERENCE TO RELATED APPLICATION

This application claims the priority benefit of Taiwan application serial no. 113146170, filed on Nov. 29, 2024. The entirety of the above-mentioned patent application is hereby incorporated by reference herein and made a part of this specification.

### BACKGROUND

### Technical Field

The disclosure relates to a display apparatus, and particularly relates to a display apparatus and a method of driving pixels thereof.

### Description of Related Art

A light-emitting diode display is a self-illuminating display that uses light-emitting diodes, that is, self-illuminating pixels with light-emitting diodes are arranged on the display panel. The method of driving the self-illuminating pixels are generally divided into pulse width modulation (PWM) circuit driving and pulse-amplitude modulation (PAM) circuit driving.

In the pulse width modulation circuit driving method, the current magnitude is controlled through the pulse-amplitude modulation block, and then the brightness and light-emitting time of the light-emitting diode are controlled by controlling the on and off time of the driving transistor located on the current path through the pulse width modulation block. However, the aforementioned driving method may not reach the ideal value for low grayscale current due to resistance-capacitance (RC) delay and insufficient carrier mobility of the driving transistor. Moreover, when the low grayscale current is too small, the efficiency of the light-emitting diode deteriorates and becomes sensitive to variations. Furthermore, the transistor is also sensitive to variations in the low grayscale current operation range, and the current is easily affected by process variations.

On the other hand, in the pulse-amplitude modulation circuit driving method, driving is achieved through a fixed current duty cycle, so the pulse width of the current is not affected by resistance-capacitance and transistor variations. The magnitude of the current is controlled by the driving transistor located on the current path to determine the brightness of the light-emitting diode. However, in the aforementioned driving method, the efficiency of the light-emitting diode may deteriorate and become sensitive to current variations due to small currents in medium and low grayscales. Although the problem of small currents may be solved by adjusting the overall duty cycle of the light-emitting diode, this approach may limit the brightness of high grayscales.

### SUMMARY

The disclosure provides a display apparatus and a method of driving pixels thereof. By dividing a single frame period into a plurality of sub-frame periods, it may achieve the effect of pulse width modulation of the light-emitting duty cycle using a pulse width modulation circuit architecture without adding additional signals or circuits.

The display apparatus of the disclosure includes a pixel array, a timing controller, a gate driver, a source driver, and an emission driving circuit. The pixel array has a plurality of self-luminous pixel circuits arranged in an array, in which each of the self-luminous pixel circuits has an emission element. The timing controller receives display data to provide pixel voltage data, at least two scan start signals, and an emission start signal in a single frame period. The gate driver receives the at least two scan start signals and is coupled to the self-luminous pixel circuits to divide the single frame period into a plurality of sub-frame periods based on the at least two scan start signals, and sequentially activate the self-luminous pixel circuits row by row in each of the sub-frame periods. The source driver receives the pixel voltage data to provide a plurality of pixel voltages corresponding to the self-luminous pixel circuits in each of the sub-frame periods, in which each of the self-luminous pixel circuits determines a driving current flowing through the emission element based on the received pixel voltage. The emission driving circuit receives the emission start signal to provide a plurality of emission signals to the self-luminous pixel circuits and determine a plurality of light-emitting times of the self-luminous pixel circuits.

The method of driving pixels of the display apparatus of the disclosure includes the following steps. The single frame period is divided into a plurality of sub-frame periods via a timing controller. A plurality of self-luminous pixel circuits are sequentially activated row by row in each of the sub-frame periods via a gate driver, and each of the self-luminous pixel circuits has an emission element. A plurality of pixel voltages corresponding to the self-luminous pixel circuits are provided in each of the sub-frame periods based on display data via a source driver, and each of the self-luminous pixel circuits determines a driving current flowing through the emission element based on the received pixel voltage. A plurality of emission signals are provided to the self-luminous pixel circuits via an emission driving circuit to determine a plurality of light-emitting times of the self-luminous pixel circuits.

Based on the above, in the display apparatus and the method of driving pixels thereof, the timing controller divides a single frame period into a plurality of sub-frame periods, enabling each self-luminous pixel circuit to perform data writing once in each sub-frame period. In other words, the brightness illuminated/emitted/provided by each self-luminous pixel circuit in the sub-frame periods is independent of each other. Thereby, the self-luminous pixel circuit may only use a pulse amplitude modulation circuit architecture, but still have the effect of pulse width modulation of the light-emitting duty cycle.

In order to make the above-mentioned features and advantages of the disclosure comprehensible, embodiments accompanied with drawings are described in detail below.

### BRIEF DESCRIPTION OF THE DRAWINGS

FIG. 1 is a system diagram of the display apparatus according to the embodiment of the disclosure.

FIG. 2A is a driving waveform diagram of the display apparatus at low grayscale according to the embodiment of the disclosure.

FIG. 2B is a driving waveform diagram of the display apparatus at low grayscale according to the embodiment of the disclosure.

FIG. 3 is a circuit diagram of the self-luminous pixel circuit of the display apparatus according to the embodiment of the disclosure.

FIG. 4A to FIG. 4C are characteristic curve diagrams of forward voltages of red light-emitting diode, green light-emitting diode, and blue light-emitting diode of the self-luminous pixel circuit according to the embodiment of the disclosure.

FIG. 4D is a current-voltage characteristic curve diagram of the transistor of the self-luminous pixel circuit according to the embodiment of the disclosure.

FIG. 5A is a scanning diagram of a pixel array of the display apparatus according to the embodiment of the disclosure.

FIG. 5B is a waveform diagram of a single horizontal scanning period of the pixel array of the display apparatus according to the embodiment of the disclosure.

FIG. 6 to FIG. 11 are driving waveform diagrams of the display apparatus according the embodiment of the disclosure.

FIG. 12 is a system diagram of the method of driving pixels of the display apparatus according to the embodiment of the disclosure.

### DESCRIPTION OF THE EMBODIMENTS

Unless otherwise defined, all terms (including technical and scientific terms) used herein have the same meaning as that commonly understood by one of ordinary skill in the art to which this disclosure belongs. It should be further understood that terms such as those defined in commonly used dictionaries should be construed as having meanings consistent with their meanings in the context of the related art and the disclosure, and are not to be construed as idealized or excessive formal meaning, unless expressly defined as such herein.

It should be understood that, although the terms “first”, “second”, “third”, or the like may be used herein to describe various elements, components, regions, layers, and/or portions, these elements, components, regions, and/or portions should not be limited by these terms. These terms are only used to distinguish one element, component, region, layer, or portion from another element, component, region, layer, or portion. Thus, “a first element,” “component,” “region,” “layer,” or “portion” discussed below may be referred to as a second element, component, region, layer, or portion without departing from the teachings herein.

The terminology used herein is for the purpose of describing particular embodiments only and is not limiting. As used herein, the singular forms “a”, “an”, and “the” are intended to include the plural forms including “at least one” unless the content clearly dictates otherwise. “Or” means “and/or”. As used herein, the term “and/or” includes any and all combinations of one or more of the associated listed items. It should also be understood that, when used in this specification, the term “including” or “includes” specify a presence of the stated feature, region, whole subject, step, operation, element, and/or part, but not excluding the presence or addition of one or more other features, regions, whole subjects, steps, operations, elements, parts, and/or a combination thereof.

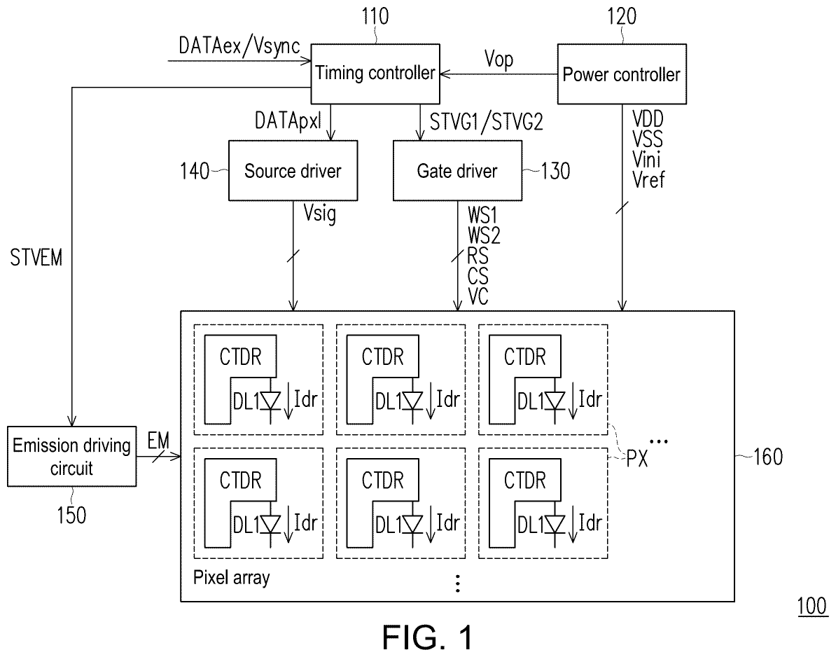

FIG. 1 is a system diagram of the display apparatus according to the embodiment of the disclosure. Referring to FIG. 1, in this embodiment, the display apparatus 100 includes a timing controller 110, a power controller 120, a gate driver 130, a source driver 140, an emission driving circuit 150, and a pixel array 160.

The pixel array 160 has a plurality of self-luminous pixel circuits PX arranged in an array, and each of the self-luminous pixel circuits PX has an emission element (e.g., a light-emitting diode DL1) and a driving circuit CTDR for driving the emission element. The power controller 120 is coupled to the timing controller 110 and the pixel array 160 to provide the operating voltage Vop required for the operation of the timing controller 110, and to provide the system high voltage VDD, system low voltage VSS, initial voltage Vini, and reference voltage Vref required for the operation of these self-luminous pixel circuits PX.

The timing controller 110 is coupled to the gate driver 130, the source driver 140, and the emission driving circuit 150, and receives display data DATAex and a vertical synchronization signal Vsync. The timing controller 110 defines the time interval of a single frame period Frame based on the vertical synchronization signal Vsync. Moreover, during the single frame period Frame, the timing controller 110 provides pixel voltage DATApxl to the source driver 140, provides at least two scan start signals (such as STVG1, STVG2) to the gate driver 130, and provides an emission start signal STVEM to the emission driving circuit 150, based on the display data DATAex.

The gate driver 130 receives scan start signals (such as STVG1, STVG2) from the timing controller 110, and is coupled to all self-luminous pixel circuits PX in the pixel array 160. The gate driver 130 divides a single frame period into a plurality of sub-frame periods based on the received scan start signals (such as STVG1, STVG2), and sequentially activates these self-luminous pixel circuits PX row by row in each of the provided sub-frame periods.

The source driver 140 receives pixel voltage DATApxl from the timing controller 110 and is coupled to all self-luminous pixel circuits PX in the pixel array 160. The source driver 140 provides a plurality of pixel voltages Vsig corresponding to these self-luminous pixel circuits PX in each of these sub-frame periods, and the driving circuit CTDR of each of these self-luminous pixel circuits PX determines the driving current Idr flowing through the light-emitting diode DL1 based on the received pixel voltage Vsig. Furthermore, each self-luminous pixel circuit PX writes the pixel voltage Vsig to the driving circuit CTDR at least twice in a single frame period, that is, once in each sub-frame period.

The emission driving circuit 150 receives the emission start signal STVEM to provide a plurality of emission signals EM to these self-luminous pixel circuits PX and to control the driving circuit CTDR to illuminate the light-emitting diode DL1 in the self-luminous pixel circuit PX, thereby determining a plurality of light-emitting times of these self-luminous pixel circuits PX. These emission signals EM have a plurality of pulses, and the pulses of the emission signal EM are used to control the number of times the light-emitting diode DL1 of the self-luminous pixel circuit PX is illuminated in a single frame period.

According to the above, the timing controller 110 divides a single frame period into a plurality of sub-frame periods, enabling each self-luminous pixel circuit PX to perform one write operation in each sub-frame period, so that the brightness illuminated/emitted/provided by each self-luminous pixel circuit PX in the sub-frame periods is independent of each other. Thereby, the self-luminous pixel circuit PX may only use a pulse amplitude modulation circuit architecture, but still have the effect of a pulse width modulation of the light-emitting duty cycle.

In the embodiment of the disclosure, the light-emitting diode DL1 may include a micro light-emitting diode, but the embodiment of the disclosure is not limited thereto.

In the embodiment of the disclosure, the method for adjusting the light-emitting duty cycle of the self-luminous pixel circuit PX is not by changing the time length of each light emission, but by changing the number of times the light-emitting diode DL1 of the self-luminous pixel circuit PX is illuminated (i.e., the number of light emissions) in a single frame period.

In the embodiment of the disclosure, the gate driver 130 may not be limited to providing a first scanning signal WS1, a second scanning signal WS2, a reset signal RS, a scan compensation signal CS, and a voltage control signal VC to the self-luminous pixel circuit PX.

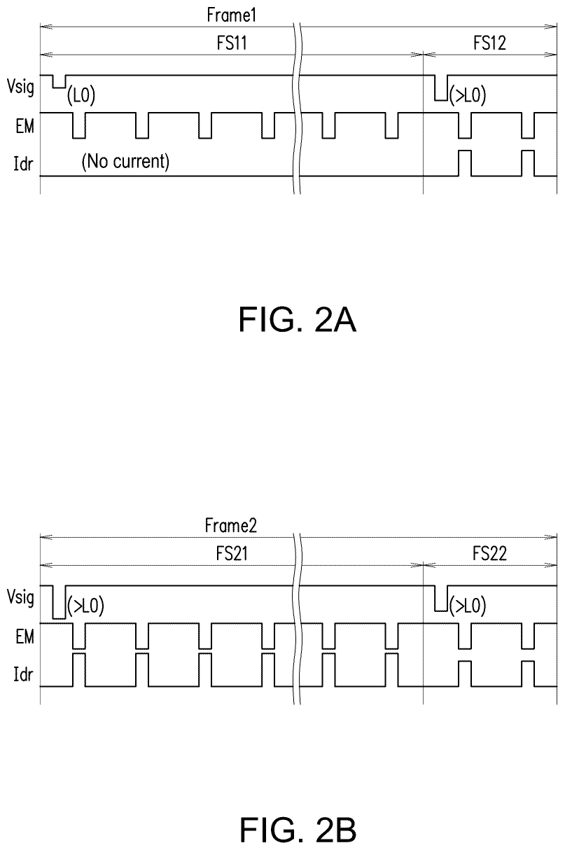

FIG. 2A is a driving waveform diagram of the display apparatus at low grayscale according to the embodiment of the disclosure. Referring to FIG. 1 and FIG. 2A. In this embodiment, a single frame period Frame1 may be divided into two sub-frame periods FS11 and FS12, and the time length of the sub-frame period FS11 is much greater than the time length of the sub-frame period FS12 (i.e., the time lengths of the sub-frame periods FS11 and FS12 are not entirely identical). For example, the pulse count of the emission signal EM in the sub-frame period FS11 to the pulse count of the emission signal EM in the sub-frame period FS12 is 9:2 (i.e., the plurality of light-emitting time ratios in the sub-frame periods FS11 and FS12 are not entirely identical), but the embodiment of the disclosure is not limited thereto.

In this embodiment, assuming the self-luminous pixel circuit PX is providing low grayscale brightness. At this time, the pixel voltage Vsig used to write to the self-luminous pixel circuit PX in the sub-frame period FS11 may correspond to the grayscale value L0 (i.e., 0 grayscale value), so that the driving current Idr of the self-luminous pixel circuit PX is 0 in the sub-frame period FS11, that is, the light-emitting diode DL1 does not emit light. Then, the pixel voltage Vsig written to the self-luminous pixel circuit PX in the sub-frame period FS12 may be greater than the grayscale value L0, so that the driving current Idr of the self-luminous pixel circuit PX is not 0 in the sub-frame period FS12, that is, the light-emitting diode DL1 emits light in the sub-frame period FS12.

Since the pulse count of the emission signal EM in the sub-frame period FS12 is much smaller than the pulse count of the emission signal EM in the sub-frame period FS11, the light-emitting effect of the self-luminous pixel circuit PX in the sub-frame period FS12 is limited, thereby achieving the effect of providing low grayscale brightness.

In the embodiment of the disclosure, in each of the sub-frame periods FS11 and FS12 of the single frame period Frame1, each of the emission signals EM has a plurality of light-emitting pulses with identical pulse width. Moreover, the pulse width of the light-emitting pulses of each emission signal EM in the sub-frame period FS11 (corresponding to the first sub-frame period) is identical to the pulse width of the light-emitting pulses in the sub-frame period FS12 (corresponding to the second sub-frame period).

FIG. 2B is a driving waveform diagram of the display apparatus at low grayscale according to the embodiment of the disclosure. Referring to FIG. 1 and FIG. 2B, in this embodiment, a single frame period Frame2 may be divided into two sub-frame periods FS21 and FS22, and the time length of the sub-frame period FS21 is much greater than the time length of the sub-frame period FS22. For example, the pulse count of the emission signal EM in the sub-frame period FS21 to the pulse count of the emission signal EM in the sub-frame period FS22 is 9:2, but the embodiment of the disclosure is not limited thereto.

In this embodiment, assuming the self-luminous pixel circuit PX is providing high grayscale brightness. At this time, the pixel voltages Vsig used to write to the self-luminous pixel circuit PX in the sub-frame periods FS21 and FS22 may be different from each other and greater than (or much greater than) the grayscale value L0 (i.e., 0 grayscale value), so that the driving current Idr of the self-luminous pixel circuit PX is not 0 in the sub-frame periods FS21 and FS22, that is, the light-emitting diode DL1 emits light in the sub-frame periods FS21 and FS22. Thereby, the self-luminous pixel circuit PX may achieve the effect of providing high grayscale brightness.

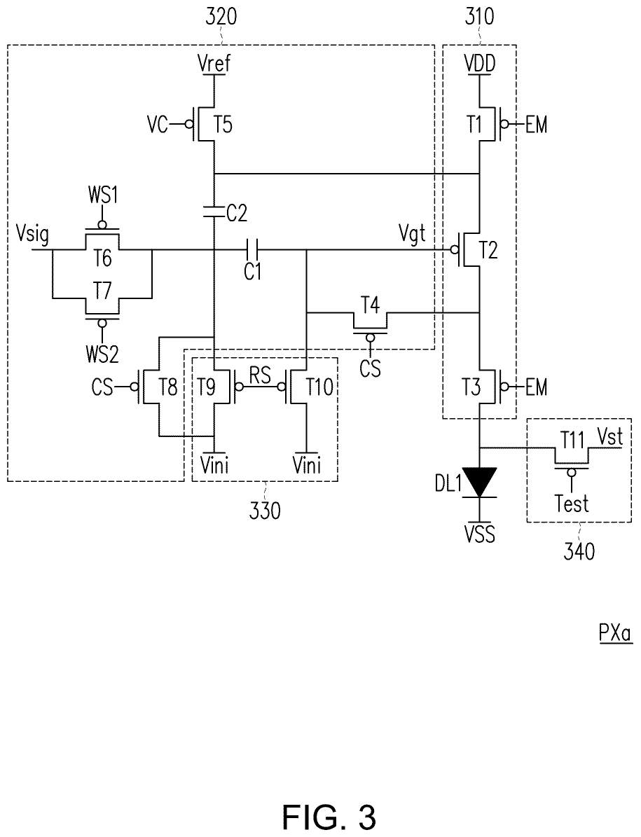

FIG. 3 is a circuit diagram of the self-luminous pixel circuit of the display apparatus according to the embodiment of the disclosure. Referring to FIG. 1 and FIG. 3, in this embodiment, the self-luminous pixel circuits PX may be self-luminous pixel circuits PXa, and each of the self-luminous pixel circuits PXa includes a light-emitting diode DL1, an emission element driving circuit 310, a data programming circuit 320, a reset circuit 330, and a test circuit 340, and the driving circuit CTDR includes at least one of the emission element driving circuit 310, the data programming circuit 320, the reset circuit 330, and the test circuit 340.

The light-emitting diode DL1 has an anode and a cathode coupled to the system low voltage VSS. The emission element driving circuit 310 receives the system high voltage VDD, one of the emission signals EM, and the gate control voltage Vgt, and is coupled to the anode of the light-emitting diode DL1 to provide the driving current Idr to the light-emitting diode DL1. The data programming circuit 320 is coupled to the gate driver 130 to receive the first scanning signal WS1 and the second scanning signal WS2, is coupled to the emission driving circuit 150, and receives one of these pixel voltages Vsig to provide the gate control voltage Vgt.

The reset circuit 330 receives the gate control voltage Vgt and the reset signal RS to reset the gate control voltage Vgt based on the reset signal RS. The test circuit 340 is coupled to the anode of the light-emitting diode DL1 and receives the test signal Test to provide the test output voltage Vst based on the test signal Test.

In this embodiment, the emission driving circuit 150 includes a first transistor T1, a second transistor T2, and a third transistor T3, and the first transistor T1, the second transistor T2, and the third transistor T3 may be, for example, P-type transistors. The first transistor T1 has a first terminal receiving the system high voltage VDD, a control terminal receiving one of the emission signals EM, and a second terminal. The second transistor T2 has a first terminal coupled to the second terminal of the first transistor T1, a control terminal receiving the gate control voltage Vgt, and a second terminal. The third transistor T3 has a first terminal coupled to the second terminal of the second transistor T2, a control terminal receiving one of the emission signals EM, and a second terminal providing the driving current Idr.

In this embodiment, the data programming circuit 320 includes a fourth transistor T4, a fifth transistor T5, a sixth transistor T6, a seventh transistor T7, an eighth transistor T8, a first capacitor C1, and a second capacitor C2, and the fourth transistor T4, the fifth transistor T5, the sixth transistor T6, the seventh transistor T7, and the eighth transistor T8 may be, for example, P-type transistors. The fourth transistor T4 has a first terminal coupled to the control terminal of the second transistor T2, a control terminal receiving the scan compensation signal CS, and a second terminal coupled to the second terminal of the second transistor T2. The fifth transistor T5 has a first terminal receiving the reference voltage Vref, a control terminal receiving the voltage control signal VC, and a second terminal coupled to the first terminal of the second transistor T2. The sixth transistor T6 has a first terminal receiving one of the pixel voltages Vsig, a control terminal receiving the first scanning signal WS1, and a second terminal.

The seventh transistor T7 has a first terminal receiving one of the pixel voltages Vsig, a control terminal receiving the second scanning signal WS2, and a second terminal coupled to the second terminal of the sixth transistor T6. The first capacitor C1 is coupled between the second terminal of the sixth transistor T6 and the control terminal of the second transistor T2, and provides the gate control voltage Vgt to the control terminal of the second transistor. The second capacitor C2 is coupled between the second terminal of the fifth transistor T5 and the second terminal of the sixth transistor T6. The eighth transistor T8 has a first terminal coupled to the second terminal of the sixth transistor T6, a control terminal receiving the scan compensation signal CS, and a second terminal receiving the initial voltage Vini. The gate control voltage Vgt may reflect the received pixel voltage Vsig.

In this embodiment, the reset circuit 330 includes a ninth transistor T9 and a tenth transistor T10, and the ninth transistor T9 and the tenth transistor T10 may be, for example, P-type transistors. The ninth transistor T9 has a first terminal coupled to the second terminal of the sixth transistor T6, a control terminal receiving the reset signal RS, and a second terminal receiving the initial voltage Vini. The tenth transistor T10 has a first terminal coupled to the control terminal of the second transistor T2, a control terminal receiving the reset signal RS, and a second terminal receiving the initial voltage Vini.

In this embodiment, the test circuit includes an eleventh transistor T11, and the eleventh transistor T11 may be, for example, a P-type transistor. The eleventh transistor T11 has a first terminal coupled to the anode of the light-emitting diode DL1, a control terminal receiving the test signal Test, and a second terminal providing the test output voltage Vst.

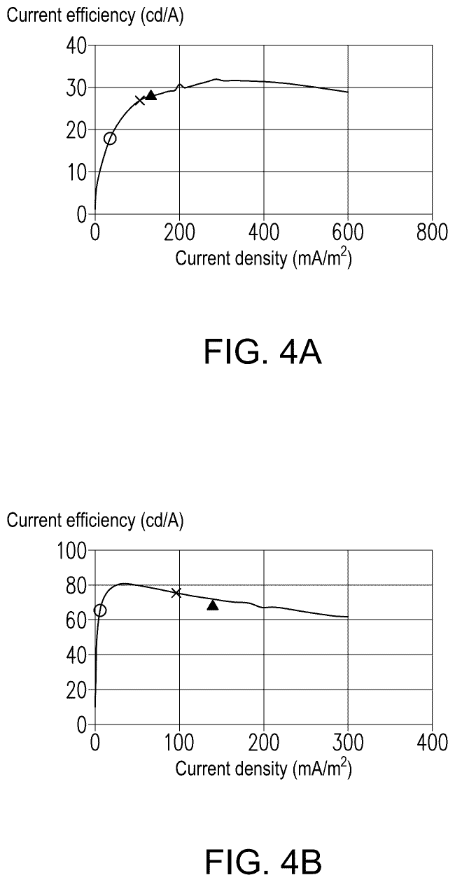

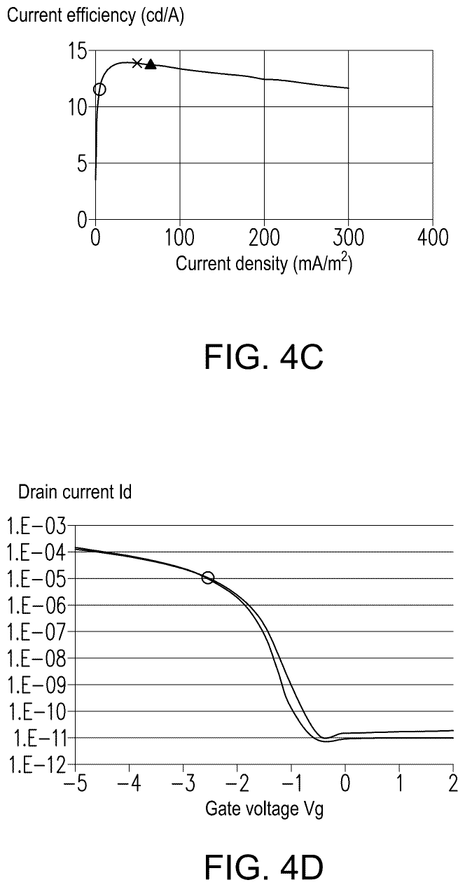

FIG. 4A to FIG. 4C are characteristic curve diagrams of forward voltages of red light-emitting diode, green light-emitting diode, and blue light-emitting diode of the self-luminous pixel circuit according to the embodiment of the disclosure. FIG. 4D is a current-voltage characteristic curve diagram of the transistor of the self-luminous pixel circuit according to the embodiment of the disclosure. Referring to FIG. 1, FIG. 3, and FIG. 4A to FIG. 4D, in this embodiment, the minimum driving current Idr for illuminating the light-emitting diode DL1 of each of these self-luminous pixel circuits PX is based on the characteristic curve of the forward voltage of the light-emitting diode DL1 and the current-voltage characteristic curve of the driving transistor (i.e., the second transistor T2) of each of these self-luminous pixel circuits PX.

FIG. 4A shows the characteristic curve of the forward voltage of the red light-emitting diode, FIG. 4B shows the characteristic curve of the forward voltage of the green light-emitting diode, and FIG. 4C shows the characteristic curve of the forward voltage of the blue light-emitting diode. As shown in the figures, “X” indicates the conversion point of the best efficiency for high grayscale brightness, “▴” indicates the conversion point of the best efficiency for medium grayscale brightness, and “O” indicates the conversion point of the best efficiency for low grayscale brightness. In the case where the high grayscale brightness is 2000 nits, the medium grayscale brightness may be 250 nits, and the low grayscale brightness may be 10 nits, but the embodiments of the disclosure are not limited thereto. Moreover, in the schematic diagram of the current-voltage characteristic curve of the transistor, “O” indicates the working point where the transistor is least sensitive to temperature.

After determining the characteristic curve of the forward voltage of the light-emitting diode, the minimum working current (i.e., the minimum driving current Idr) of the light-emitting diode is determined based on the current-voltage characteristic curve of the transistor and the light-emitting efficiency of the light-emitting diode. As shown in FIG. 4A to FIG. 4C, the minimum acceptable current for the red light-emitting diode may be 40 uA, and the minimum acceptable current for the green light-emitting diode may be 10 uA.

Next, the shortest duty cycle of the shortest sub-frame period in the sub-frame periods is determined. For example, the shortest duty cycle may be defined as 1%. Moreover, the red light-emitting diode, green light-emitting diode, and blue light-emitting diode may have different combinations of duty cycles, that is, the scanning signals for writing data into the self-luminous pixel circuits PX of the red light-emitting diode, green light-emitting diode, and blue light-emitting diode are divided.

Then, based on the circuit architecture of the self-luminous pixel circuit PX, the channel size of the transistor and the magnitude of the system high voltage VDD are determined. For example, in the case where the maximum current demand within the shortest duty cycle is 180 microamperes (μA), the channel ratio of the driving transistor may be 40/4.5 micrometers (μm), and the system high voltage VDD may be 11 volts (V).

Moreover, the duty cycle of the maximum sub-frame period is determined based on the maximum brightness specification. For example, assuming the highest brightness specification is 2000 nits, that is, the sum of the duty cycles of the maximum sub-frame period and the minimum sub-frame period is 10%, then the duty cycle occupied by the maximum sub-frame period may be 9%.

Finally, the combination of brightness pixel voltage Vsig data is determined by the combination of duty cycles of the sub-frame periods. For example, a combination of pixel voltage Vsig data for the duty cycles of the maximum sub-frame period and the minimum sub-frame period for all grayscales may be established, as shown in Table 1.

TABLE 1

| | | |
|---|---|---|
| | Maximum sub-frame | Minimum sub-frame |
| Brightness | period | period |

| | | | | | |
|---|---|---|---|---|---|
| 10 | nits | 9.5 | V | 11 | V |
| 20 | nits | 9.45 | V | 11 | V |

| | | |
|---|---|---|
| . . . | . . . | . . . |

| | | | | | |
|---|---|---|---|---|---|
| 250 | nits | 7 | V | 11 | V |
| 251 | nits | 11 | V | 8.5 | V |

| | | |
|---|---|---|
| . . . | . . . | . . . |

| | | | | | |
|---|---|---|---|---|---|
| 2000 | nits | 5 | V | 5 | V |

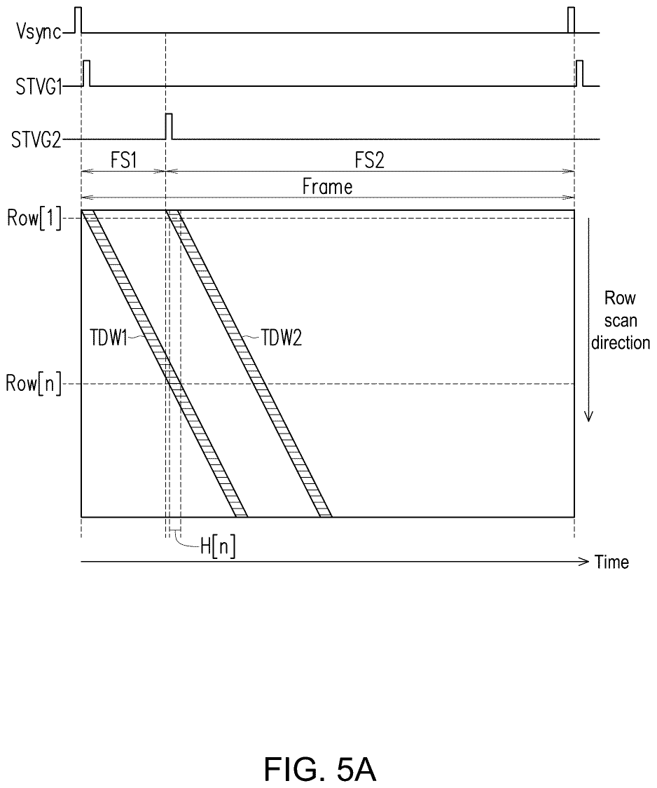

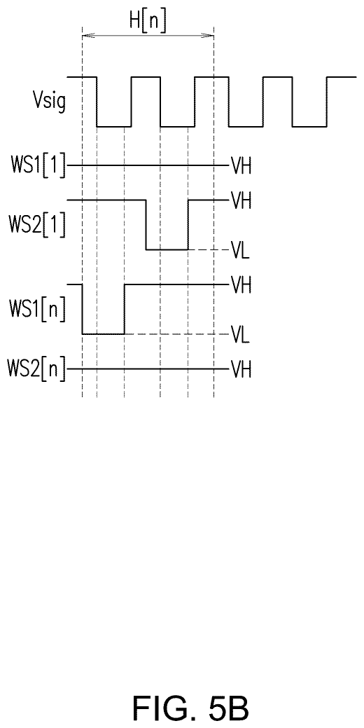

FIG. 5A is a scanning diagram of a pixel array of the display apparatus according to the embodiment of the disclosure. Referring to FIG. 1, FIG. 3, and FIG. 5A, in this embodiment, a single frame period Frame may be, for example, defined by a pulse of the vertical synchronization signal Vsync, and the scan start signals STVG1 and STVG2 may alternately form pulses to distinguish sub-frame periods FS1 and FS2. When the scan start signal STVG1 forms a pulse, the self-luminous pixel circuits PX of the pixel array 160 may be activated row by row starting from the first row Row[1], as shown by the scanning timing TDW1, to perform the first data writing of the self-luminous pixel circuits PX; and in response to the scan start signal STVG2 forming a pulse, the self-luminous pixel circuits PX of the pixel array 160 may be activated again row by row starting from the first row Row[1], as shown by the scanning timing TDW2, to perform the second data writing of the self-luminous pixel circuits PX.

FIG. 5B is a waveform diagram of a single horizontal scanning period of the pixel array of the display apparatus according to the embodiment of the disclosure. Referring to FIG. 1, FIG. 3, FIG. 5A, and FIG. 5B, in this embodiment, in response to the self-luminous pixel circuits PX in the nth row Row[n] performing the first data writing, the self-luminous pixel circuits PX in the 1st row Row[1] perform the second data writing, as shown by the horizontal scanning period H[n], where n is a positive integer greater than 0.

At this time, the first scanning signal WS1[1] received by the self-luminous pixel circuits PX in the 1st row Row[1] may remain in a disabled state (e.g., at high voltage VH), and the second scanning signal WS2[1] received by the self-luminous pixel circuits PX in the 1st row Row[1] may switch to an enabled state (e.g., at low voltage VL), enabling the self-luminous pixel circuits PX in the 1st row Row[1] to perform data writing; and the first scanning signal WS1[n] received by the self-luminous pixel circuits PX in the nth row Row[n] may switch to an enabled state, while the second scanning signal WS2[n] received by the self-luminous pixel circuits PX in the nth row Row[n] may remain in a disabled state, enabling the self-luminous pixel circuits PX in the nth row Row[n] to perform data writing.

In this embodiment, the time when the first scanning signal WS1[n] switches to an enabled state is different from the time when the second scanning signal WS2[1] switches to an enabled state (i.e., they do not overlap in time), ensuring that the first data writing and the second data writing operations do not interfere with each other, allowing the duration and sequence of sub-frame periods FS1 and FS2 to be unrestricted, that is, they may be allocated more freely.

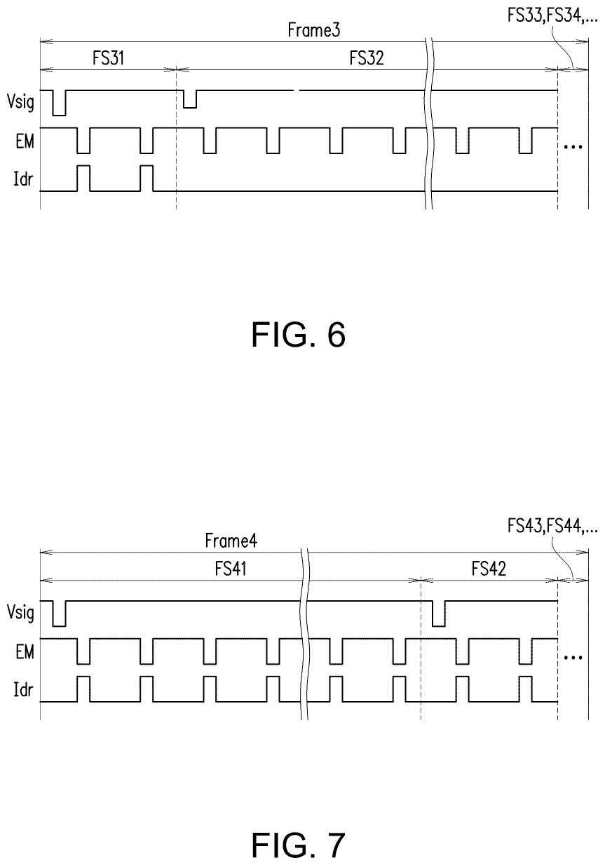

FIG. 6 to FIG. 11 are driving waveform diagrams of the display apparatus according the embodiment of the disclosure. Referring to FIG. 1, FIG. 2A, FIG. 2B, and FIG. 6, in this embodiment, a single frame period Frame3 may be divided into a plurality of sub-frame periods (such as FS31, FS32, FS33, FS34), and it is assumed that the pulse widths of the pulses of the emission signal EM are identical to each other. The time length of the 2nd sub-frame period FS32 is much longer than the time lengths of other sub-frame periods (such as FS31, FS33, FS34), that is, the pulse count of the emission signal EM in the 2nd sub-frame period FS32 is much greater than the pulse count of the emission signal EM in other sub-frame periods (such as FS31, FS33, FS34).

Referring to FIG. 1, FIG. 2A, FIG. 2B, and FIG. 7, in this embodiment, a single frame period Frame4 may be divided into a plurality of sub-frame periods (such as FS41, FS42, FS43, FS44), and it is assumed that the pulse widths of the pulses of the emission signal EM are identical to each other. The time length of the 1st sub-frame period FS41 is much longer than the time lengths of other sub-frame periods (such as FS42, FS43, FS44), that is, the pulse count of the emission signal EM in the 1st sub-frame period FS41 is much greater than the pulse count of the emission signal EM in other sub-frame periods (such as FS42, FS43, FS44).

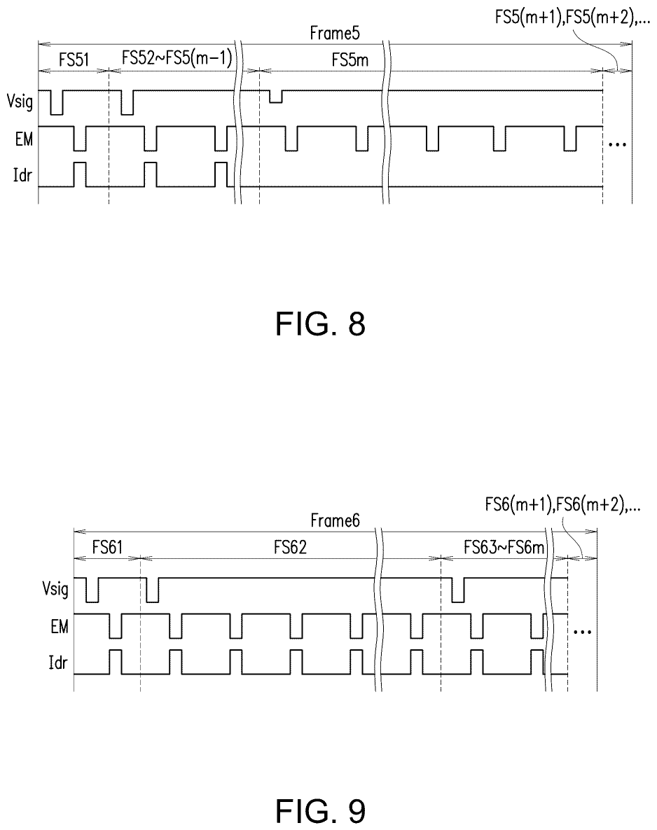

Referring to FIG. 1, FIG. 2A, FIG. 2B, and FIG. 8, in this embodiment, a single frame period Frame5 may be divided into a plurality of sub-frame periods (such as FS51, FS52 to FS5(m−1), FS5m, FS5(m+1), FS5(m+2)), and it is assumed that the pulse widths of the pulses of the emission signal EM are identical to each other, where m is a positive integer greater than 0. As shown in the figure, the time length of the mth sub-frame period FS5m is much longer than the time lengths of other sub-frame periods (such as FS51, FS52 to FS5(m−1), FS5(m+1), FS5(m+2)), that is, the pulse count of the emission signal EM in the mth sub-frame period FS5m is much greater than the pulse count of the emission signal EM in other sub-frame periods (such as FS51, FS52 to FS5(m−1), FS5(m+1), FS5(m+2)).

Referring to FIG. 1, FIG. 2A, FIG. 2B, and FIG. 9, in this embodiment, a single frame period Frame6 may be divided into a plurality of sub-frame periods (such as FS61, FS62, FS63 to FS6m, FS6(m+1), FS6(m+2)), and it is assumed that the pulse widths of the pulses of the emission signal EM are identical to each other, where m is a positive integer greater than 0. As shown in the figure, the time length of the 2nd sub-frame period FS62 is much longer than the time lengths of other sub-frame periods (such as FS61, FS63 to FS6m, FS6(m+1), FS6(m+2)), that is, the pulse count of the emission signal EM in the 2nd sub-frame period FS62 is much greater than the pulse count of the emission signal EM in other sub-frame periods (such as FS61, FS63 to FS6m, FS6(m+1), FS6(m+2)).

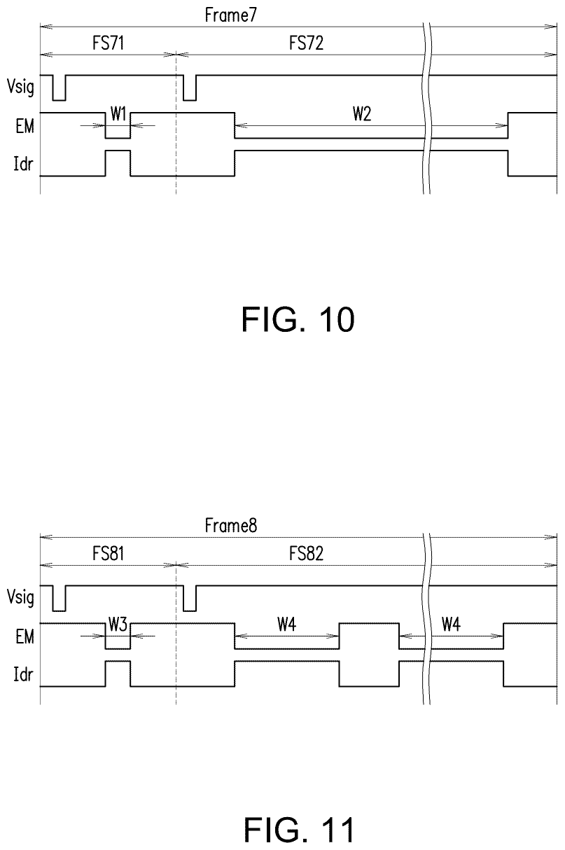

Referring to FIG. 1, FIG. 2A, FIG. 2B, and FIG. 10, in this embodiment, a single frame period Frame7 may be divided into 2 sub-frame periods FS71 and FS72, and single light emission occurs in the sub-frame periods FS71 and FS72, that is, the emission signal EM only forms a single pulse in the sub-frame periods FS71 and FS72. Here, the time length of the 2nd sub-frame period FS72 is much longer than the time lengths of the 1st sub-frame period FS71, and the pulse width W2 of the emission signal EM in the 2nd sub-frame period FS72 is much greater than the pulse width W1 of the emission signal EM in the 1st sub-frame period FS71.

Referring to FIG. 1, FIG. 2A, FIG. 2B, and FIG. 11, in this embodiment, a single frame period Frame8 may be divided into 2 sub-frame periods FS81 and FS82, where single light emission occurs in the 1st sub-frame period FS81, and multiple light emissions (for example, 2 times) occur in the 2nd sub-frame period FS82, that is, the emission signal EM only forms a single pulse in the 1st sub-frame period FS81, and the emission signal EM forms at least 2 pulses in the 2nd sub-frame period FS82. Here, the time length of the 2nd sub-frame period FS82 is much longer than the time lengths of the 1st sub-frame period FS81, and the pulse width W4 of each pulse of the emission signal EM in the 2nd sub-frame period FS82 is greater than the pulse width W3 of the emission signal EM in the 1st sub-frame period FS81.

Based on the embodiments in FIG. 10 and FIG. 11, in a single frame period (such as Frame7 and Frame8), the pulse width of the light-emitting pulse of each of these emission signals EM in one (corresponding to the third sub-frame period) of the sub-frame periods (such as FS71, FS72, FS81, FS82) may be different from the pulse width of the light-emitting pulse in another different one (corresponding to the fourth sub-frame period) of the sub-frame periods (such as FS71, FS72, FS81, FS82).

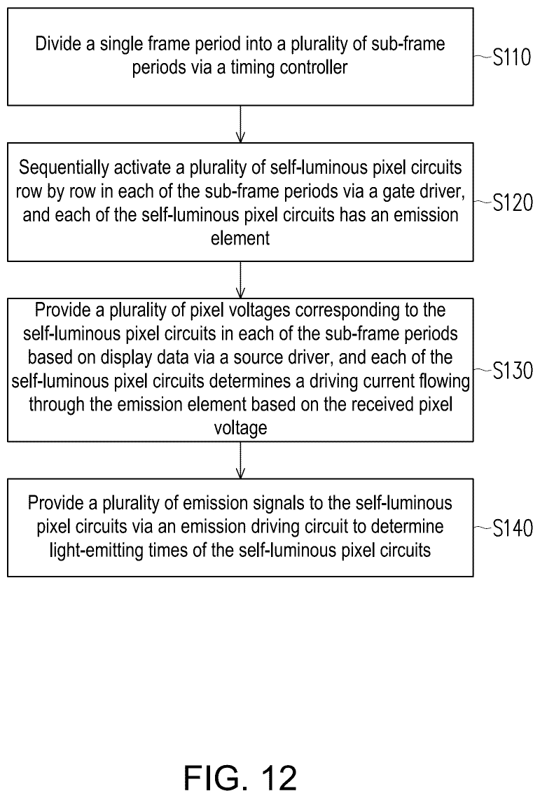

FIG. 12 is a system diagram of the method of driving pixels of the display apparatus according to the embodiment of the disclosure. Referring to FIG. 12, in this embodiment, the method of driving pixels includes the following steps. In step S110, a single frame period is divided into a plurality of sub-frame periods via a timing controller. In step S120, a plurality of self-luminous pixel circuits are sequentially activated row by row in each of the sub-frame periods via a gate driver, and each of the self-luminous pixel circuits has an emission element.

In step S130, a plurality of pixel voltages corresponding to the self-luminous pixel circuits are provided in each of the sub-frame periods based on display data via a source driver, and each of the self-luminous pixel circuits determines a driving current flowing through the emission element based on the received pixel voltage. In step S140, a plurality of emission signals are provided to the self-luminous pixel circuits via an emission driving circuit to determine a plurality of light-emitting times of the self-luminous pixel circuits. The order of steps S110, S120, S130, and S140 is for illustration purposes, and the embodiment of the disclosure is not limited thereto; moreover, the details of steps S110, S120, S130, and S140 may refer to the embodiments shown in FIG. 1 to FIG. 11, which will not be repeated here.

In summary, in the display apparatus and the method of driving pixels thereof, the timing controller divides a single frame period into a plurality of sub-frame periods, enabling each self-luminous pixel circuit to perform data writing once in each sub-frame period. In other words, the brightness illuminated/emitted/provided by each self-luminous pixel circuit in the sub-frame periods is independent of each other. Thereby, the self-luminous pixel circuit may only use a pulse amplitude modulation circuit architecture, but still have the effect of pulse width modulation of the light-emitting duty cycle.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A display apparatus, comprising:
a pixel array, having a plurality of self-luminous pixel circuits arranged in an array, wherein each of these self-luminous pixel circuits has an emission element;
a timing controller, receiving display data to provide pixel voltage data, at least two scan start signals, and an emission start signal in a single frame period;
a gate driver, receiving the at least two scan start signals and coupled to these self-luminous pixel circuits to divide the single frame period into a plurality of sub-frame periods based on the at least two scan start signals, and sequentially activate these self-luminous pixel circuits row by row in each of these sub-frame periods;
a source driver, receiving the pixel voltage data to provide a plurality of pixel voltages corresponding to these self-luminous pixel circuits in each of these sub-frame periods, wherein each of these self-luminous pixel circuits determines a driving current flowing through the emission element based on the received pixel voltage; and
an emission driving circuit, receiving the emission start signal to provide a plurality of emission signals to these self-luminous pixel circuits and determine a plurality of light-emitting times of these self-luminous pixel circuits.

2. The display apparatus according to claim 1, wherein in the single frame period, a plurality of time lengths of these sub-frame periods are not entirely identical.

3. The display apparatus according to claim 1, wherein in the single frame period, a plurality of light-emitting time ratios of these sub-frame periods are not entirely identical.

4. The display apparatus according to claim 1, wherein in each of these sub-frame periods of the single frame period, a plurality of light-emitting pulses of each of these emission signals have identical pulse width.

5. The display apparatus according to claim 4, wherein in the single frame period, for each of these emission signals, a pulse width of these light-emitting pulses in a first sub-frame period among these sub-frame periods is identical to a pulse width of these light-emitting pulses in a second sub-frame period different from the first sub-frame period among these sub-frame periods.

6. The display apparatus according to claim 4, wherein in the single frame period, for each of these emission signals, a pulse width of these light-emitting pulses in a third sub-frame period among these sub-frame periods is not identical to a pulse width of these light-emitting pulses in a fourth sub-frame period different from the third sub-frame period among these sub-frame periods.

7. The display apparatus according to claim 1, wherein a minimum driving current for illuminating the emission element of each of these self-luminous pixel circuits is based on a characteristic curve of a forward voltage of the emission element and a current-voltage characteristic curve of a driving transistor of each of these self-luminous pixel circuits.

8. The display apparatus according to claim 1, wherein each of these self-luminous pixel circuits comprises:
the emission element, having an anode and a cathode coupled to a system low voltage;
an emission element driving circuit, receiving a system high voltage, one of these emission signals, and a gate control voltage, and coupled to the anode of the emission element to provide the driving current to the emission element;
a data programming circuit, coupled to the gate driver to receive a first scanning signal and a second scanning signal, coupled to the emission driving circuit, and receiving one of these pixel voltages to provide the gate control voltage; and
a reset circuit, receiving the gate control voltage and a reset signal to reset the gate control voltage based on the reset signal.

9. The display apparatus according to claim 8, wherein the emission driving circuit comprises:
a first transistor, having a first terminal receiving the system high voltage, a control terminal receiving one of these emission signals, and a second terminal;
a second transistor, having a first terminal coupled to the second terminal of the first transistor, a control terminal receiving the gate control voltage, and a second terminal; and
a third transistor, having a first terminal coupled to the second terminal of the second transistor, a control terminal receiving one of these emission signals, and a second terminal providing the driving current.

10. The display apparatus according to claim 9, wherein the data programming circuit comprises:
a fourth transistor, having a first terminal coupled to the control terminal of the second transistor, a control terminal receiving a scan compensation signal, and a second terminal coupled to the second terminal of the second transistor;
a fifth transistor, having a first terminal receiving a reference voltage, a control terminal receiving a voltage control signal, and a second terminal coupled to the first terminal of the second transistor;
a sixth transistor, having a first terminal receiving one of these pixel voltages, a control terminal receiving the first scanning signal, and a second terminal;
a seventh transistor, having a first terminal receiving one of these pixel voltages, a control terminal receiving the second scanning signal, and a second terminal coupled to the second terminal of the sixth transistor;
a first capacitor, coupled between the second terminal of the sixth transistor and the control terminal of the second transistor to provide the gate control voltage;
a second capacitor, coupled between the second terminal of the fifth transistor and the second terminal of the sixth transistor; and
an eighth transistor, having a first terminal coupled to the second terminal of the sixth transistor, a control terminal receiving the scan compensation signal, and a second terminal receiving an initial voltage.

11. The display apparatus according to claim 10, wherein the reset circuit comprises:
a ninth transistor, having a first terminal coupled to the second terminal of the sixth transistor, a control terminal receiving the reset signal, and a second terminal receiving the initial voltage; and
a tenth transistor, having a first terminal coupled to the control terminal of the second transistor, a control terminal receiving the reset signal, and a second terminal receiving the initial voltage.

12. The display apparatus according to claim 8, wherein each of the self-luminous pixel circuits further comprises a test circuit coupled to the anode of the emission element and receiving a test signal to provide a test output voltage based on the test signal.

13. The display apparatus according to claim 12, wherein the test circuit comprises:
an eleventh transistor, having a first terminal coupled to the anode of the emission element, a control terminal receiving the test signal, and a second terminal providing the test output voltage.

14. The display apparatus according to claim 1, wherein the emission element comprises a micro light-emitting diode.

15. A method of driving pixels of a display apparatus, comprising:
dividing a single frame period into a plurality of sub-frame periods via a timing controller;
sequentially activating a plurality of self-luminous pixel circuits row by row in each of the sub-frame periods via a gate driver, wherein each of the self-luminous pixel circuits has an emission element;
providing a plurality of pixel voltages corresponding to the self-luminous pixel circuits in each of the sub-frame periods based on display data via a source driver, wherein each of the self-luminous pixel circuits determines a driving current flowing through the emission element based on the received pixel voltage; and
providing a plurality of emission signals to the self-luminous pixel circuits via an emission driving circuit to determine a plurality of light-emitting times of the self-luminous pixel circuits.

16. The method of driving pixels according to claim 15, wherein in the single frame period, a plurality of time lengths of the sub-frame periods are not entirely identical.

17. The method of driving pixels according to claim 15, wherein in the single frame period, a plurality of light-emitting time ratios of the sub-frame periods are not entirely identical.

18. The method of driving pixels according to claim 15, wherein in each of the sub-frame periods of the single frame period, a plurality of light-emitting pulses of each of the emission signals have identical pulse width.

19. The method of driving pixels according to claim 18, wherein in the single frame period, for each of these emission signals, a pulse width of these light-emitting pulses in a first sub-frame period among these sub-frame periods is identical to a pulse width of these light-emitting pulses in a second sub-frame period different from the first sub-frame period among these sub-frame periods.

20. The method of driving pixels according to claim 18, wherein in the single frame period, for each of these emission signals, a pulse width of these light-emitting pulses in a third sub-frame period among these sub-frame periods is not identical to a pulse width of these light-emitting pulses in a fourth sub-frame period different from the third sub-frame period among these sub-frame periods.

21. The method of driving pixels according to claim 18, wherein a minimum driving current for illuminating the emission element of each of these self-luminous pixel circuits is based on a characteristic curve of a forward voltage of the emission element and a current-voltage characteristic curve of a plurality of transistor of each of these self-luminous pixel circuits.

22. The method of driving pixels according to claim 15, wherein the emission element comprises a micro light-emitting diode.
